(19) United States
(12) Patent Application Publication
(10) Pub. No.: US 2020/0322524 A1
(43) Pub. Date: Oct. 8, 2020

(54) DRONE DESIGNED FOR VIEWING A DISTANT SCENE

(71) Applicant: PARROT DRONES, Paris (FR)

(72) Inventor: Eric SIMON, LYON (FR)

(21) Appl. No.: 16/305,761

(22) PCT Filed: May 30, 2017
(86) PCT No.: PCT/EP2017/063026

§ 371 Date: Nov. 29, 2018

(30) Foreign Application Priority Data
May 31, 2016 (FR) 1654873

(51) Int. Cl. H04N 5/232; G03B 13/36; G02B 26/00; G02B 3/14; G03B 15/00; B64C 39/02; B64D 47/08; H04N 5/225; H04N 5/247; H04N 7/18

(52) U.S. Cl. CPC H04N 5/23212; G03B 13/36; G02B 26/005; G02B 3/14; G03B 15/006; B64C 39/024; B64C 2201/127; H04N 5/2253; H04N 5/23299; H04N 5/247; H04N 7/18; B64C 2201/027; B64D 47/08

(57) ABSTRACT

According to one aspect, the present description relates to a drone designed for viewing a distant scene, comprising a flying platform and at least one first camera mechanically secured to the platform. The first camera comprises an image sensor with a detection surface, an electro-optical system for forming images of the scene on the detection surface of the image sensor, able to give the camera a dimensional angular field of view of less than 47°. According to the first aspect, the electro-optical system comprises at least one first optical group, which is fixed, comprising a plurality of optical diopters, an electro-optical device with variable optical power able to adjust the focusing of the image on the detection surface, and a control unit controlling the electro-optical device.

### BACKGROUND OF THE INVENTION

### Technical Field

The present invention relates to drones adapted for viewing a distant scene, and more particularly light drones, typically less than 25 kg. The present description also relates to methods for forming images using such drones.

### Background of the Invention

Drones, or UAVs (Unmanned Aerial Vehicles), are uninhabited aircraft, piloted remotely and capable of performing specific tasks during their flight.

Drones, originally developed for military applications, are now also being developed for civilian purposes, for example for commercial applications or road or agricultural surveillance applications. Known for example are the Bebop® drone by the company Parrot® or the S1000® and Phantom 4® drones by the company DJI®. These drones are so-called light drones, with a mass typically below 25 kg.

Drones are generally equipped with a motor, or several rotors driven by respective motors, a series of sensors (accelerometers, rate gyros, altimeters, etc.) and a front camera intended to capture images of the scene toward which the drone is moving. A vertical-facing camera may also be provided to guarantee stabilization of the drone and/or to capture images of the overflown terrain. The front camera is generally a so-called “short focal distance” camera. A short focal distance camera is a camera provided with an optical system whereof the focal distance is generally less than 35 mm equivalent 24×36, corresponding approximately to a diagonal field of 63°. Short focal distance cameras allow the acquisition of images with a large field angle, i.e., for which the field of the image is wider than the field of view of a person.

There is currently a need for a drone equipped with a camera having a limited field angle allowing an acquisition of detailed images of the scene, i.e., enlarged images relative to human vision, or at least corresponding substantially to human vision.

Traditional cameras with a standard or restricted field angle are commercially available. However, these cameras may be difficult to adapt for light drones. Indeed, obtaining an enlarged image requires using a camera with a long focal length, i.e., a focal length greater than 50 mm, equivalent 24×36, which corresponds approximately to a diagonal field of 47°. The depth of field is generally defined as the region of space in which an element of the scene must be found to be able to obtain an image that the optical system accepts as sharp. It is inversely proportional to the square of the focal distance; thus, the depth of field of an image with a restricted field angle is short, which requires a very precise focusing of the optical system. In traditional cameras, the focusing, or adjustment of the focus, is done using high precision mechanical systems. Yet these mechanical systems are sensitive to vibrations, and are also too heavy and too cumbersome for drones, which, by their design, are heavy and subject to vibrations.

One aim of the present description consists of proposing a drone adapted for viewing a distant scene, the on-board camera of which is compatible with the constraints of a light drone, namely a camera in particular having a low mass and a low sensitivity to vibrations, and which also guarantees an acquisition of detailed images with precise focusing.

### BRIEF DESCRIPTION OF THE INVENTION

According to a first aspect, the present invention relates to a drone adapted for viewing a distant scene, comprising a flying platform and at least one first camera mechanically secured to the platform, wherein the first camera comprises:
an image sensor with a detection surface;
an electro-optical system for forming images of the scene on the detection surface of the image sensor, the electro-optical system being able to give the camera a dimensional angular field of view of less than 47° and comprising:
   at least one first optical group, which is fixed, comprising a plurality of optical diopters;
   an electro-optical device with variable optical power able to adjust the focusing of the image on the detection surface; and
   a control unit for controlling the electro-optical device.

Such a drone has the advantage of providing enlarged images of a scene relative to the vision of a human being, or substantially corresponding to the vision of a human being, with very good focus, which allows the user to assess the details of the scene that would not be visible in a wide-angle image.

According to one or several example embodiments, the diagonal angular field of the camera smaller than 32°, corresponding to a focal distance greater than 75 mm equivalent 24×36. According to one or several example embodiments, the diagonal angular field of the camera smaller than 16°, corresponding to a focal distance greater than 150 mm equivalent 24×36.

The electro-optical device adapted to the adjustment of the focus according to the present description may comprise any device having a focal distance variable by electrical command Such a device has the advantage, relative to a device implementing a movement of an optical element for the adjustment of the focus, of not being sensitive to vibrations.

According to one or several example embodiments, the electro-optical device with variable optical power comprises an optical diopter deformable by electrical command; this may for example be a device having an electrically deformable liquid liquid interface (for example a liquid lens with electro-wetting of the Varioptic® type) or it may be a device having a deformable polymer membrane (see for example the Polight®, Wavelens®, Optotune® technologies).

According to one or several example embodiments, the electro-optical device with variable optical power comprises a liquid crystal device (for example, the Lensvector® technology).

According to one or several example embodiments, the electro-optical device with variable optical power is positioned on the front face of the electro-optical system, the detection surface being positioned on the rear face of said electro-optical system.

According to one or several example embodiments, the electro-optical system includes at least two optical groups, which are fixed, each comprising a plurality of optical diopters, the electro-optical device with variable optical power being positioned between two of said optical groups.

According to one or several example embodiments, the electro-optical system comprises at least one positive optical group (optional), on the side of the object, followed by a second negative optical group, then symmetrically, a third negative optical group and a fourth positive optical group (optional), the electro-optical device with variable optical power being positioned between said two negative optical groups.

The first, second and third optical groups are for example respectively optical groups with a positive, negative, negative meniscus.

Positive or negative optical group refers to a respectively convergent or divergent optical group.

According to one or several example embodiments, the drone further comprises a telemetry device capable of measuring the distance between the scene and the electro-optical system, connected to the control unit of the electro-optical device with variable optical power, so as to allow an automatic focusing of the image as a function of the measured distance.

According to one or several example embodiments, the drone comprises a module for analyzing the sharpness of the image, the module for analyzing the sharpness of the image being connected to the control unit of the electro-optical device with variable optical power, so as to allow automatic focusing of the image based on the sharpness analysis.

According to one or several example embodiments, the first camera is mounted pivoting around at least one rotation axis connected to the flying platform. For example, the first camera rotates around all three rotation axes.

According to one or several example embodiments, the drone further comprises a second camera with a focal distance different from that of the first camera, adapted for observing the scene with a field different from that of the first camera.

The present description also relates to methods for forming images using drones according to the first aspect.

According to one or several example embodiments, the image method further comprises automatically focusing the image by varying the optical power using the electro-optical device with variable optical power.

According to one or several example embodiments, the automatic focusing of the image comprises:
at least one measurement of a distance between the first camera and the scene using a telemeter;
determining an electrical voltage value to be applied to the electro-optical device with variable optical power as a function of the measured distance;
controlling the electro-optical device with variable optical power as a function of the determined voltage value.

According to one or several example embodiments, the automatic focusing of the image comprises:
analyzing the sharpness of at least one current image with determination of a sharpness score,
comparing the sharpness score of the current image with a sharpness score of at least one previous image,
modifying the electrical voltage value of the electro-optical device with variable optical power based on a result of the comparison thus determined.

### BRIEF DESCRIPTION OF THE DRAWINGS

Other advantages and features of the invention will appear upon reading the description, illustrated by the following figures:

FIG. 1, a general schematic view of an example drone according to the present description;

FIGS. 2A and 2B, diagrams illustrating an on-board camera and a block diagram of the control of the electro-optical device of the camera, in two example embodiments of a drone according to the present description;

FIGS. 3A and 3B, example embodiments of an electro-optical system of a camera in a drone according to the present description;

FIGS. 4A, 4B, 4C and 4D, example embodiments of an electro-optical system of the type of FIG. 3A, with different positions of the opening diaphragm;

FIGS. 5A, 5B, 5C and 5D, different example embodiments of an electro-optical system of the drone, according to FIG. 3B and FIGS. 5E to 5L illustrate example embodiments of double Gauss;

FIGS. 6A, 6B, 6C and 6D, schematic perspective views of articulation examples of a camera in a drone according to the present description;

FIGS. 7A and 7B, block diagrams illustrating examples of automatic focusing in a camera of a drone according to the present description;

FIG. 8, an example drone according to the present description with a first and a second camera.

### DETAILED DESCRIPTION

In the figures, identical elements are identified using the same references. For legibility of the figures, the illustrated elements are not shown to scale.

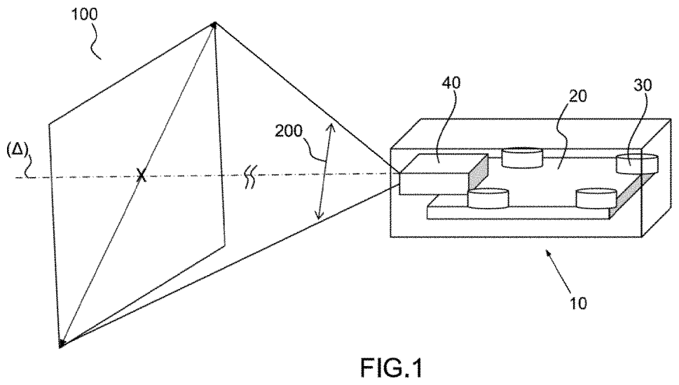

An example drone, shown schematically by a rhomb referenced 10, is shown in FIG. 1. The drone 10 can be a quadricopter, a sailwing or any other light drone intended for taking images. The drone 10 comprises a platform 20 and one or several rotors 30 mounted on the platform or attached by rigid connections to the platform. The drone 10 is equipped with one or several horizontal- and/or vertical-facing camera(s).

In FIG. 1, for simplification reasons, only one camera 40 is shown; in this example, it is a horizontal-facing camera, also called front camera. The camera is adapted for observing a scene 100 and is characterized by a diagonal angular field of view 200.

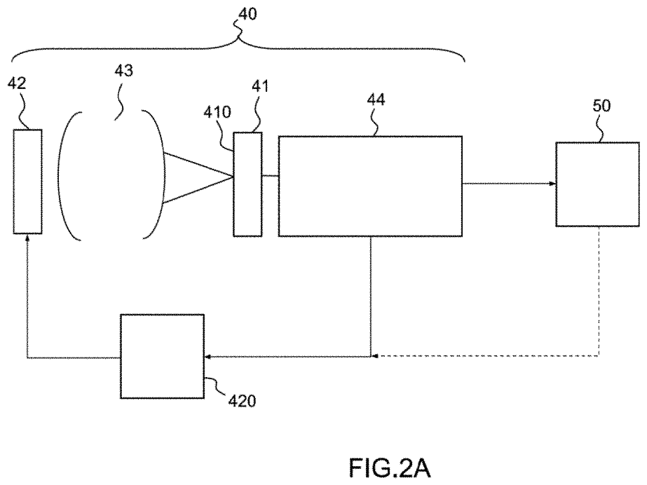

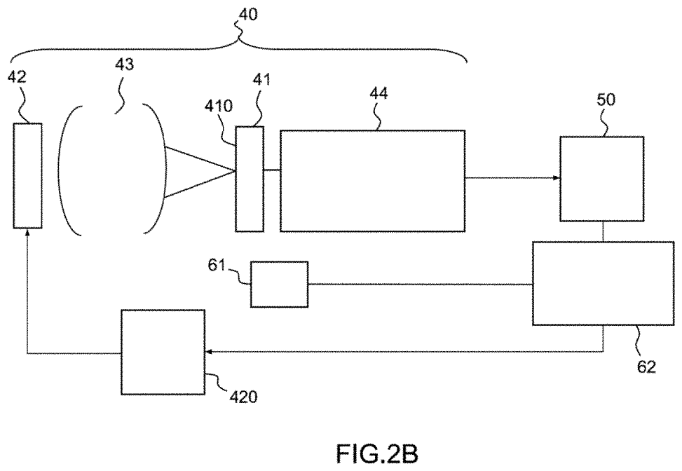

FIGS. 2A and 2B show examples of drone cameras according to the present description.

In these examples, the camera 40 comprises an electronic system (42, 43) and an image sensor 41, or image detector, with a detection surface 410 having given dimensions. The image sensor 41 can be a 1D or 2D sensor, for example of the CCD or CMOS type.

The electro-optical system comprises at least a first optical group 43, comprising a plurality of optical diopters and electro-optical device with variable optical power, referenced 42, and simply referred to hereinafter as “electro-optical device”. For a detection surface with given dimensions, the electro-optical system made up of the optical group(s) and the electro-optical device defines the diagonal angular field of the camera. In the present description, we consider a diagonal angular field smaller than or equal to 47°, which corresponds to a focal distance greater than 50 mm equivalent 24×36.

In the examples illustrated in FIGS. 2A and 2B, the electrical signals generated by the image sensor 41 are processed by a processing unit 44, or ISP (Image System Processing), for example a microprocessor. The ISP can be connected to a control 50 of the drone by a control interface of the camera (not shown). According to one or several example embodiments, the ISP can be integrated into the control unit of the drone or connected to a control unit outside the drone (remote control), by a wireless communication means. The remote processing of the images can also be done on a deferred basis.

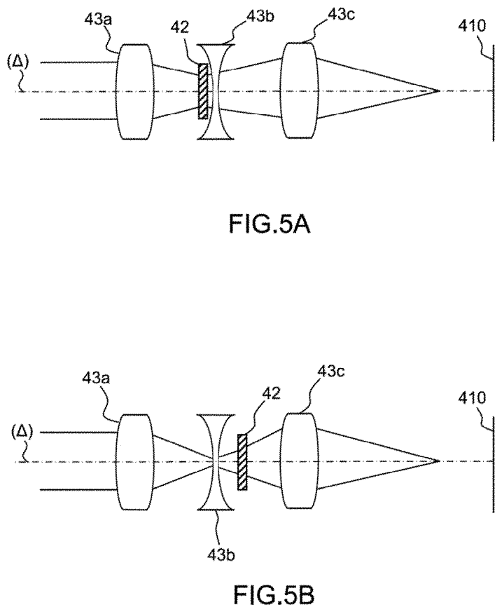

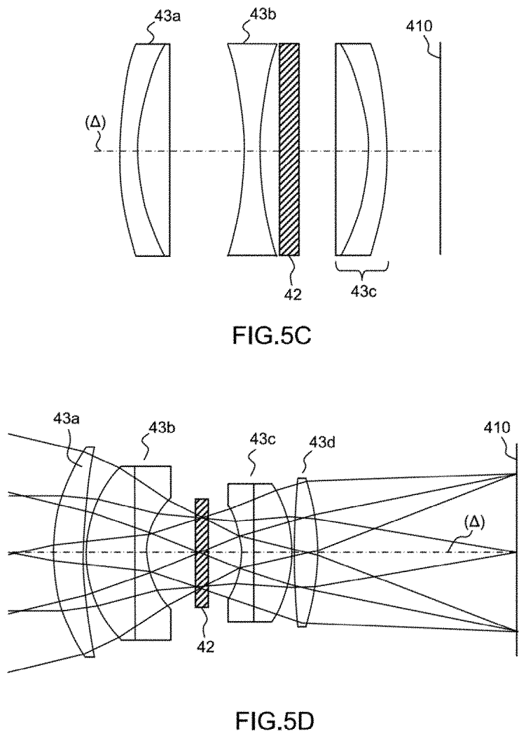

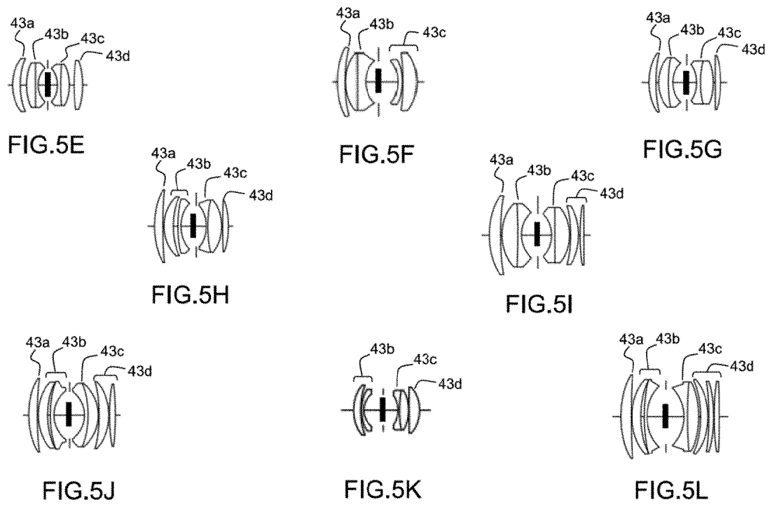

Each fixed group is made up of a set of several optical diopters; it may for example be made up of a fixed lens, convergent or divergent, or a set of several fixed lenses, convergent or divergent, assembled to one another to generate a specific optical function. Examples of optical groups will be described later in connection with FIGS. 5A-5D.

The electro-optical device 42 is an optical device whose optical power, which is inversely proportional to the focal distance, can be modified by varying the electrical voltage applied across the terminals of the electro-optical device. Such a device has the advantage of being able to perform focusing without mechanical movement of any of the optical elements making up said electro-optical device. A control unit 420 makes it possible to control the voltage applied to the electro-optical device.

According to one or several example embodiments, the electro-optical device with variable optical power comprises an optical diopter deformable by electrical command.

For example, the electro-optical device with variable optical power comprises a liquid lens with electro-wetting, for example a liquid lens as marketed by the company Varioptic®. Such a liquid lens is based on the deformation of a diopter formed by the interface between two liquids, including an electrically conductive liquid and an electrically nonconductive liquid, via the application of an electrical voltage. Such a liquid lens, described for example in patent FR 2,791,439 B 1, in particular has a high value of the optical power x useful opening diameter product, which makes it possible to produce a significant adjustment range of the optical power on a device having a pupil with a large opening diameter.

The electro-optical device with variable optical power may also comprise a deformable polymer membrane: this may for example use technologies marketed by the companies Polight® and Wavelens®, in which a transparent polymer membrane is controlled by an optical electromechanical microsystem (more simply called MEMs), or the technology marketed by the company Optotune®, in which a deformable polymer membrane separates two chambers filled with fluid with different refraction indices, the pressure in the two chambers being controlled to deform the polymer membrane.

According to one or several example embodiments, the electro-optical device with variable optical power comprises a liquid crystal device (for example the technology marketed by the company Lensvector®).

As illustrated in FIG. 2A, the control unit 420 for controlling the electrical device can be electrically connected to the ISP 44 (solid line) or be electrically connected to the control unit of the drone 50 (dotted line) or can also be connected to a control unit outside the device, for example to a wireless communication means.

According to one or several example embodiments, an image processing module, integrated into the ISP or into a control unit inside or outside the drone, makes it possible to determine the control voltage, to be applied to the electro-optical device 42 based on the image processing thus done, for example an analysis of the sharpness of the images, as will be described in more detail hereinafter.

According to one or several example embodiments, a phase detection system, integrated into the image sensor, can be used to determine the focusing to be done and the control voltage to be applied to the electro-optical device 42.

In the example shown in FIG. 2B, the drone further comprises a telemetry device 61, 62, able to measure a distance between the scene and the electro-optical system. In one example embodiment, the telemetry device is integrated into the camera. The telemetry device more specifically comprises a transceiver device 61 and a computing unit 62 for determining the distance. The transceiver device can be based on the sending of a light wave (optical or lidar telemeter) or a soundwave (sonar) or a radiofrequency wave (radar). As will be described in more detail hereinafter, the computing unit can determine a control voltage to be applied by the control unit 420 to the electro-optical device based on the measured distance in order to perform automatic focusing of the electro-optical system.

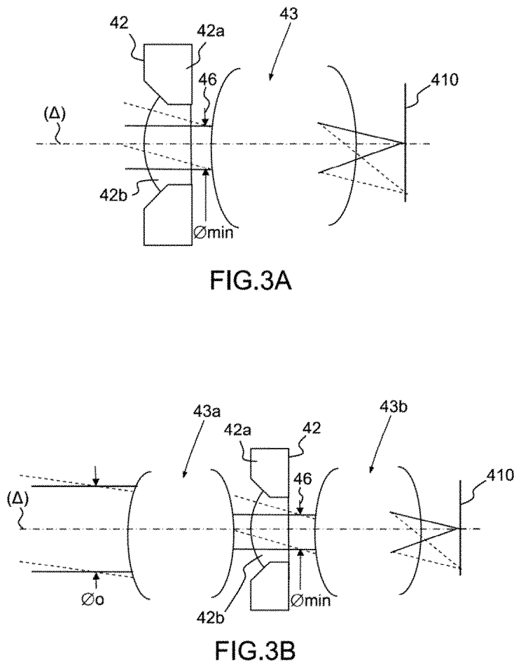

FIGS. 3A and 3B show two specific examples of electro-optical systems. In these examples, the electro-optical device 42 is shown in the form of a liquid lens with electro-wetting symbolized by a liquid-liquid interface 42b and electrodes 42a. However, any other electro-optical device as previously described may be used.

The optical axis of the electro-optical system is denoted (A). The solid lines and the dotted lines show the paths of an incident light beam in the electro-optical system respectively following a first and a second direction.

In the example of FIG. 3A, the electro-optical device 42 is positioned upstream from the fixed optical group(s) 43, i.e., on the front face of the electro-optical system, the detection surface 410 being positioned on the rear face of said electro-optical system (so-called “design add-on” arrangement. In the example of FIG. 3B, the electro-optical device 42 is positioned between two fixed optical groups 43a (front optical group) and 43b (rear optical group), according to an arrangement called “design add-in”.

In these figures, Øₘᵢₙ denotes the diameter of the opening diaphragm 46 of the electro-optical system. In FIG. 3B, Ø_{O} is the diameter of the opening pupil of the electro-optical system in the object space, i.e., the conjugated pupil of the opening diaphragm by the front optical group 43a. In both of these examples, preference is given to an opening diaphragm 46 close to the electro-optical device 42 so as to avoid any vignetting by the electro-optical device.

One advantage of an electro-optical system of the type shown in FIG. 3A (“add-on”) is that it is possible to transform an optical system made up of one or several fixed optical group(s) into an electro-optical system, without modifying the fixed optical group(s), by simply adding the electro-optical device upstream from the system.

An electro-optical system of the type shown in FIG. 3B (“add-in”) on the contrary requires designing the system by taking into account, for the dimensioning of the fixed optical group(s), that of the electro-optical device.

However, in an electro-optical system of the type shown in FIG. 3B, it is possible to maximize the digital opening of the system for an electro-optical device with a given useful opening diameter, which makes it possible to reduce the exposure time and thereby limit the “unsharpness” of the images due to movements and/or vibrations of the drone.

Furthermore, in an arrangement of the “add-in” type as shown in FIG. 3B, the focusing resolution is refined relative to an “add-on” arrangement for an equivalent voltage control on the electro-optical device, which makes it possible to perform even more precise focusing. Thus, using the notation of FIG. 3B, where Ø_{O} refers to the diameter of the opening pupil of the electro-optical system in the object space and Øₘᵢₙ refers to the diameter of the opening pupil of the electro-optical system in the space of the electro-optical device, one generates, for a variation dP of the optical power of the electro-optical device, an optical power variation of the electro-optical system in the case of FIG. 3B lower than that of the electro-optical system in the case of FIG. 3A in a ratio (Øₘᵢₙ/Ø₀)².

In the examples of FIGS. 3A and 3B, the opening diaphragm 46 of the electro-optical system is close to the electro-optical device 42, i.e., there is no fixed optical group between the electro-optical device 42 and the opening diaphragm 46.

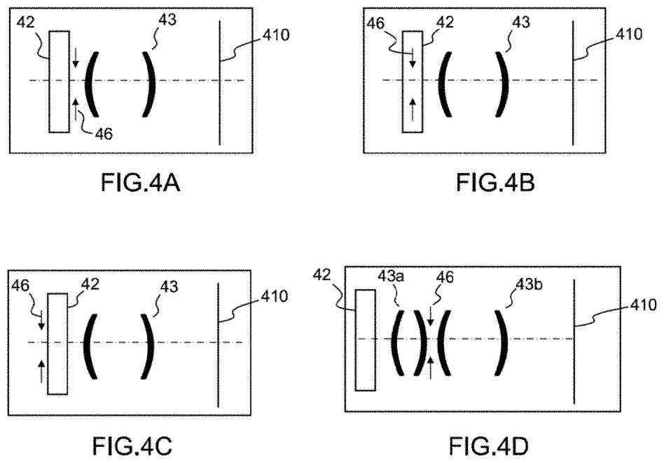

FIGS. 4A to 4D show variants of the position of the opening diaphragm in the case of an electro-optical system of the type of FIG. 3A (“add-on”). It is recalled that the opening diaphragm is the physical opening of the system that limits the quantity of light able to reach the detection surface 410, and which as a result makes it possible to control the exposure and the depth of field. Of course, these same variants can be considered for an electro-optical system of the type of FIG. 3B (“add-in”).

In the case of FIGS. 4A, 4B, 4C, the opening diaphragm 46 is close to the electro-optical device 42, whereas in the case of FIG. 4D, the opening diaphragm 46 is separated from the electro-optical device 42 by an optical group 43a. This last configuration is less advantageous because it requires a large useful opening diameter for the electro-optical device 42, without this useful opening diameter limiting the opening of the electro-optical system. In the example of FIG. 4B, the electro-optical device 42 defines the opening diaphragm such that the diameter Øₘᵢₙ of the opening diaphragm is equal to the useful opening diameter of the electro-optical device. This configuration makes it possible to optimize the digital opening of the electro-optical system for a useful diameter of the given electro-optical device.

FIGS. 5A-5D show example embodiments of specific electro-optical systems of the “add-in” type.

In the examples shown in FIGS. 5A to 5C, the electro-optical device 42 is integrated into a Cooke triplet or one of its derivatives (for example the Tessar, Elmar, Taylor2, Heliar, etc. derivatives) and in the example shown in FIG. 5D, the electro-optical device 42 is integrated within a so-called “double Gauss” system.

A Cooke triplet generally comprises a combination of three optical groups, a first convergent optical group 43a, a second divergent optical group 43b and a third convergent optical group 43c, the divergent optical group being placed between the convergent optical groups, generally near the opening diaphragm. A Cooke triplet is an optical combination that allows a good correction of aberrations over a wide field.

As shown respectively in FIGS. 5A and 5B, the electro-optical device 42 can be placed upstream or downstream from the divergent optical group 43b, i.e., between the first convergent optical group 43a and the second divergent optical group 43b or between the second divergent optical group 43b and the third convergent optical group 43c. Advantageously, the opening diaphragm (not shown in FIGS. 5A and 5B) is located near the electro-optical device 42 and/or the second divergent optical group 43b.

FIG. 5C shows a derivative of a Cooke triplet called “Heliar”. A Heliar-type system is a formula with 5 optical elements in 3 groups. It is a Cooke triplet improved by doubling of the 2 end convergent elements, which has a 50° field and good luminosity (f/4.5).

FIG. 5D shows an example electro-optical system of the double Gauss type within which the electro-optical device 42 is integrated. The double Gauss system may comprise a positive first optical group 43a, in this example an optical group with a positive meniscus, on the object side, followed by a negative second group 43b, in this example an optical group with a negative meniscus, then, symmetrically, a negative third group 43c, in this example an optical group with a negative meniscus and a positive fourth group 43d. The symmetry of the system and the splitting of the optical power into several elements makes it possible to reduce the optical aberrations in the system. In the example of FIG. 5D, the electro-optical device 42 is located between the two groups 43b and 43c with negative menisci, approximately centered.

In the example of FIG. 5D, the opening diaphragm (not shown) can be positioned near the electro-optical device 42, like in the examples previously described.

FIGS. 5E to 5L more precisely illustrate example embodiments of double Gauss systems.

The system may comprise, from the object toward the image sensor, a first optical group 43a (optional), a second fixed optical group 43b, for example comprising two lenses and three or four optical diopters, the electro-optical device 42, a third fixed optical group 43c for example comprising two lenses and three or four optical diopters, a fourth optical group 43d (optional).

According to one or several example embodiments, the faces of the second and third groups 43b, 43c facing toward the electro-optical device 42 are concave and the faces of the second and third groups 43b, 43c facing away from the electro-optical device 42 are convex.

According to one or several example embodiments, the lenses of the second group and the third group formed cemented doublets.

According to one or several example embodiments, a glass slide or a spectral filter can be arranged between the electro-optical device and one or the other of the second and third optical groups.

One advantage of such an arrangement is the ability to produce an electro-optical system with an optical opening pupil diameter larger than the useful optical diameter of the electro-optical device with variable power.

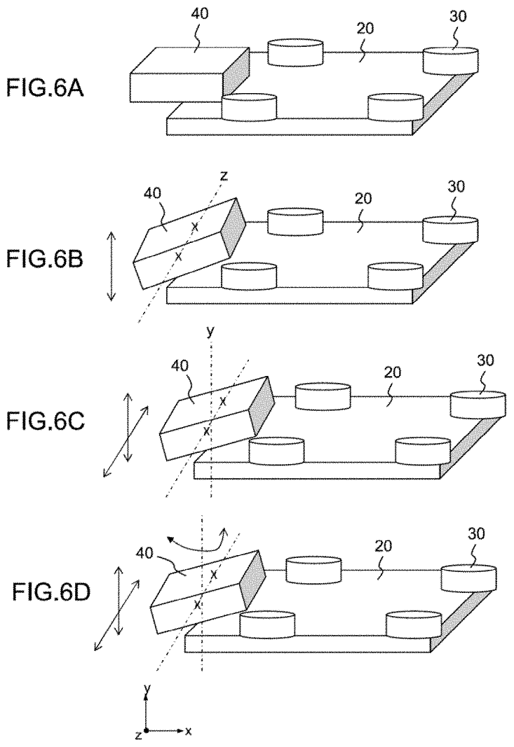

Whatever the configuration of the electro-optical system, the camera 40 is mechanically secured to the platform 20 of the drone, i.e., mechanically connected to the platform and may be arranged on one face or the other of the platform (above or below). As shown in FIG. 6A, in one or several embodiments, the camera 40 can be fixed by embedding on the platform 20 of the drone or connected by any other appropriate means. The camera 40 may further be removable, for replacement purposes, for example.

The electro-optical system of the camera may be positioned along an axis substantially parallel to the axis X, substantially comprised in the plane of the platform, and thus provide a horizontal facing. According to one alternative, the electro-optical system of the camera 40 may be positioned along an axis substantially parallel to the axis Y substantially perpendicular to that of the platform, and thus provide a vertical facing.

In one or several embodiments, the camera 40 can be mounted rotating relative to the platform 20 of the drone. It can rotate along a single axis, for example the axis Z, as shown in FIG. 6B, via a pivot link. It can rotate along two axes, for example the axes Y and Z, as shown in FIG. 6C, via a ball pin. It may also rotate along all three axes X, Y and Z, as shown in FIG. 6D, via a ball joint. In the example of FIGS. 6B, 6C and 6D, the camera 40 is said to have multiaxial sighting.

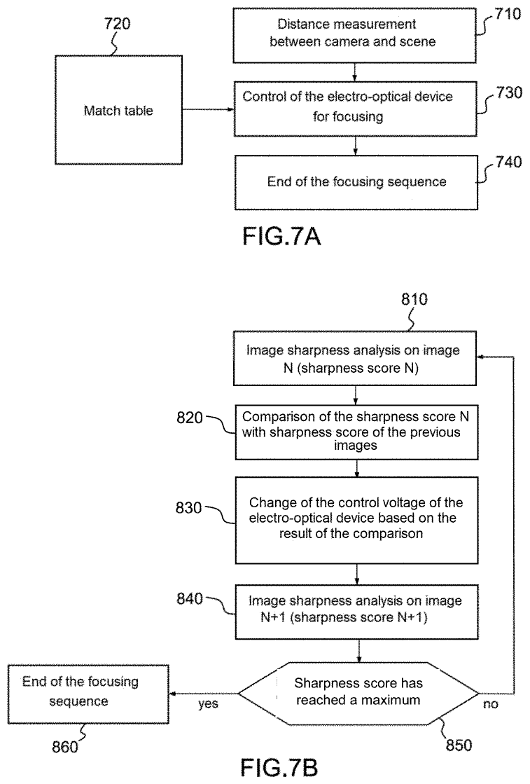

FIGS. 7A and 7B illustrate two examples of steps of example methods for automatic focusing of images in a drone according to the present description.

FIG. 7A illustrates an automatic focus method for images in an open loop, for example done using a telemetry device as described in FIG. 2B. According to one example, this method includes a step 710 for measuring the distance between the camera 40 and the scene. From distance data established for example owing to the computing unit 62 (FIG. 2B), voltage values to be applied to the electro-optical device 42 to perform the focusing are determined, for example from the database stored in a match table 720, then sent to the control unit 420 to control the electro-optical device. Once the focusing is obtained, the focusing sequence is considered complete (step 740). A new focusing sequence can then be carried out for a new image.

FIG. 7B illustrates another method for automatic focusing of the images. In this example, the method includes closed-loop slaving of the voltage applied to the electro-optical device by an iterative algorithm carried out on a series of successive images. Thus for example, the method includes a step 810 for analyzing the sharpness of an image N and assigns this image N a sharpness score N. A preliminary step may consist of defining a first voltage value to be applied using an open-loop focusing, like that of FIG. 7A, described above.

A step 820 consists of comparing the sharpness score N with the sharpness score of the previous image N−1 or two or more previous images. A step 830 next consists of modifying the value of the control voltage of the electro-optical device 42 based on the result of the comparison 820. The modification of the control voltage can be determined using a dichotomic algorithm A sharpness analysis of the following image N+1 is next done (step 840), which determines a sharpness score N+1. A test 850 consists of verifying whether the sharpness score has reached a predefined maximum score. If the maximum score is not reached, the method is repeated from step 810. If the maximum score is reached, then the focusing sequence is completed (step 860).

The automatic focusing methods previously described can be combined. It is thus possible to perform a first focusing based on a measurement of the distance, then to refine it through focusing done using image processing, for example a sharpness analysis.

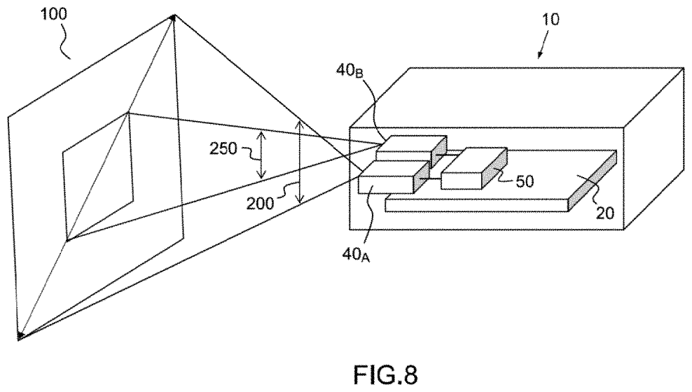

According to one or several example embodiments, the drone according to the present invention includes a second camera 40_{B}, for example a front camera, secured (or not) to a first camera 40_{A}, for example a front camera, as shown schematically in FIG. 8. The cameras can observe the same scene, but have different focal distances to observe different fields of the scene. Thus, in the example illustrated in FIG. 8, the first camera 40_{A} has a diagonal angular field 200 wider than the diagonal angular field 250 of the second camera 40_{B}. One and/or the other of the two cameras has an electro-optical device with variable optical power as previously described. When only one of the cameras has an electro-optical device, it is advantageous for it to be the camera with a greater focal distance (more restricted field) to provide the focusing (second camera 40_{B} in the example of FIG. 8).

The first and second cameras 40_{A} and 40_{B} can each have their own processing unit (ISP) or share the same processing unit, as illustrated in FIG. 8; they can be connected to the control unit 50 of the drone. The control unit 50 (or the shared ISP as the case may be) can merge the image data received by the first camera 40_{A} with the image data received by the second camera 40_{B} to generate a zoom effect. The merging of the images can also be done remotely, on a deferred basis.

Although it has been described through a certain number of detailed example embodiments, the drone according to the present description comprises different alternatives, modifications and improvements that will appear obviously to one skilled in the art, with the understanding that these various alternatives, modifications and improvements are within the scope of the invention, as defined by the following claims.

1. A drone adapted for viewing a distant scene, comprising a flying platform and at least one first camera, mechanically secured to the platform, the first camera comprising:
an image sensor with a detection surface;
an electro-optical system for forming images of the scene on the detection surface of the image sensor, the electro-optical system being able to give the camera a dimensional angular field of view of less than 47° and comprising:
at least one first optical group, which is fixed, comprising a plurality of optical diopters;
an electro-optical device with variable optical power able to adjust the focusing of the image on the detection surface; and
a control unit for controlling the electro-optical device.

2. The drone according to claim 1, wherein the electro-optical device with variable optical power comprises an optical diopter deformable by applying an electrical voltage.

3. The drone according to claim 2, wherein the electro-optical device with variable optical power comprises a liquid lens with electro-wetting.

4. The drone according to claim 1, wherein the electro-optical device with variable optical power is positioned on the front face of the electro-optical system, the image sensor being positioned on the rear face of said electro-optical system.

5. The drone according to claim 1, wherein the electro-optical system includes at least two optical groups, which are fixed, each comprising a plurality of optical diopters, the electro-optical device with variable optical power being positioned between two of said optical groups.

6. The drone according to claim 1, further comprising a telemetry device capable of measuring a distance between the scene and the electro-optical system, the telemetry device being connected to the control unit of the electro-optical device with variable optical power, so as to allow an automatic focusing of the image as a function of the measured distance.

7. The drone according to claim 1, further comprising a module for analyzing the sharpness of the image, the module for analyzing the sharpness of the image being connected to the control unit of the electro-optical device with variable optical power, so as to allow automatic focusing of the image based on the sharpness analysis.

8. The drone according to claim 1, wherein the first camera is mounted pivoting around at least one rotation axis connected to the flying platform.

9. The drone according to claim 8, wherein the first camera is mounted pivoting around all three rotation axes.

10. The drone according to claim 1, wherein the first camera is removable.

11. The drone according to claim 1, further comprising a second camera with a focal distance different from that of the first camera, adapted for observing the scene with a field different from that of the first camera.

12. A method for forming images using a drone according to claim 1, comprising automatically focusing the image by varying the optical power using the electro-optical device with variable power.

13. The method according to claim 12, wherein the automatic focusing comprises:
measuring at least one distance between the first camera and the scene,
determining an electrical voltage value to be applied to the electro-optical device with variable optical power as a function of the measured distance,
controlling the electro-optical device with variable optical power as a function of the determined voltage value.

14. The method according to claim 12, wherein the automatic focusing comprises:
analyzing the sharpness of at least one current image with determination of a sharpness score,
comparing the sharpness score of the current image with a sharpness score of at least one previous image,
modifying the electrical voltage value of the electro-optical device with variable optical power based on a result of the comparison thus determined.
